(19) United States
(12) Patent Application Publication
(10) Pub. No.: US 2026/0220913 A1
(43) Pub. Date: Jul. 30, 2026

(54) MULTI-OBJECT IMAGES AND COMPLEMENTARY OBJECT IMAGES RECOMMENDATION

(71) Applicant: Pinterest, Inc., San Francisco, CA (US)

(72) Inventors: Yue Li Du, San Carlos, CA (US); Ben Alexander, Sunnyvale, CA (US); Mikhail Antonenka, Warsaw (PL); Hao-Yu Wu, Palo Alto, CA (US)

(73) Assignee: Pinterest, Inc., San Francisco, CA (US)

(21) Appl. No.: 19/036,921

(22) Filed: Jan. 24, 2025

(51) Int. Cl. G06V 10/764; G06Q 30/0601; G06V 10/40; G06V 10/74; G06V 10/77

(52) U.S. Cl. CPC G06V 10/764; G06Q 30/0631; G06V 10/40; G06V 10/761; G06V 10/7715

(57) ABSTRACT

Disclosed are systems and methods that connect an input image, such as an individual product image, to lifestyle images that include multiple products, and then to one or more complementary product images. For example, when a user provides or selects a product image, the disclosed implementations determine one or more lifestyle images of multiple products that include the product or include another, visually similar, product. Still further, the disclosed implementations may also determine, for each of the multiple products in the lifestyle image, a set of complementary product images that may work well together and with the product in the input image.

### BACKGROUND

Users frequently encounter individual product images online but struggle to envision how these products might fit into a broader context or be styled with other items. Traditional recommendation systems typically suggest products that are visually similar to a product viewed by a user. For example, these services show other black dresses when a user views a black dress. While such recommendations can be useful, they often fail to recommend other types of products that naturally complement each other in real-world settings. As a result, users often have trouble visualizing how different types of products may be utilized or fit into a real-world environment. For example, users cannot visualize furniture pieces that work together in a room or clothing items that form a cohesive outfit. As such, users cannot make informed decisions.

### BRIEF DESCRIPTION OF THE DRAWINGS

FIG. 1A is a block diagram illustrating a recommendation system that generates one or more multi-object images and corresponding complementary object image recommendations, according to exemplary implementations of the present disclosure.

FIG. 1B is a transition diagram illustrating an example transitions from an input image to a plurality of multi-object images and corresponding complementary object images, utilizing the recommendation system discussed with respect to FIG. 1A, according to exemplary implementations of the present disclosure.

FIG. 2 is a block diagram illustrating an exemplary computing environment that may be utilized or include the components discussed with respect to FIGS. 1A and 1B, according to exemplary implementations of the present disclosure.

FIG. 3 is an example multi-object image object embedding generation process, according to exemplary implementations of the present disclosure.

FIG. 4 is an example complementary object embedding generation process, according to exemplary implementations of the present disclosure.

FIG. 5 is an example input image response process, according to exemplary implementations of the present disclosure.

FIG. 6 is an example complementary object image determination process, according to exemplary implementations of the present disclosure.

FIG. 7 is an example machine learning model training process, according to exemplary implementations of the present disclosure.

FIG. 8 is a block diagram illustrating an exemplary computing resource, according to exemplary implementations of the present disclosure.

### DETAILED DESCRIPTION

Online platforms, such as shopping platforms, social networking sites, etc., often struggle to help users visualize how products can fit into their lives or be used alongside other products. While these platforms show users individual products, they lack effective ways to demonstrate how different products work together in real-world settings. For example, when a user finds a piece of furniture or clothing they like, the user may want to see how others have styled these products or what complementary products would work well with their selection. Traditional recommendation systems often rely on purchase history or manually curated collections, which can miss the nuanced visual relationships between products and fail to provide the contextualized inspiration that users seek.

The disclosed implementations address these challenges through systems and methods that connect an input image, such as an individual product image, to images that include multiple products (e.g., lifestyle images), also referred to herein as “multi-object images,” and then to one or more complementary product images. In some implementations, complementary product images may be images that only include a single product and/or an image of a product that can be purchased from a seller. Likewise, in some implementations, an input image may be an image that only includes a single product.

While the examples discussed herein relate to products represented in images, the disclosed implementations are equally applicable to other objects, such as animals, plants, etc. Accordingly, as used herein, an image that includes only a single product is referred to herein as an “object image.” A complementary product image is referred to herein as a “complementary object image.”

When a user provides or selects an input image of an object, the disclosed implementations search through a defined corpus of multi-object images to select one or more multi-object images that include the object, or include another object that is visually similar to the object. The disclosed implementations also determine, for each selected multi-object image, complementary object images corresponding to objects included in the respective multi-object image. This allows users to discover complementary objects that may work well together and with the object included in the input image, because these objects appear together, for example, as previously used by other users as shown in the multi-object image.

As discussed in more detail herein, the disclosed implementations provide users with both the inspirational context they need to visualize objects in use and practical recommendations for complementary objects, significantly improving the shopping or discovery experience. The disclosed implementations operate in real-time to provide recommendations and can utilize any type of image as an input image.

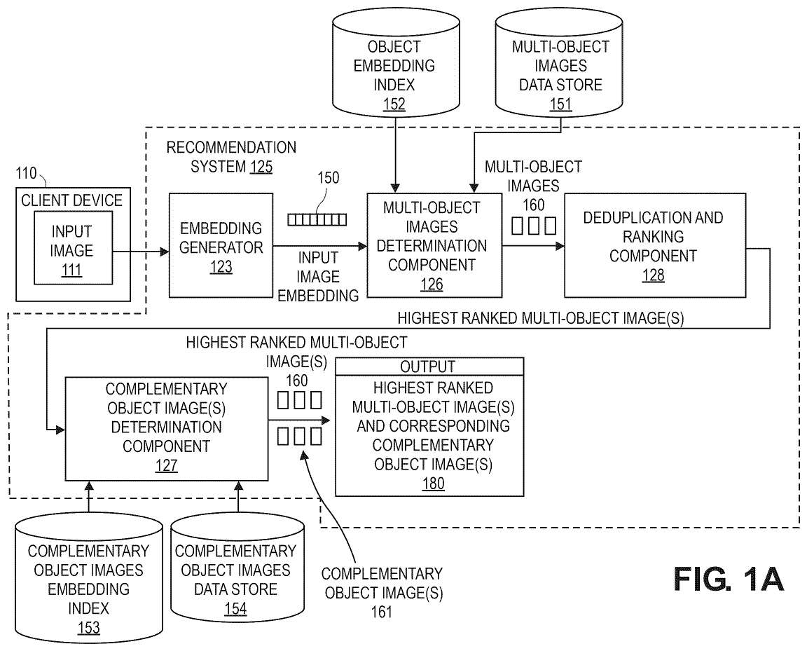

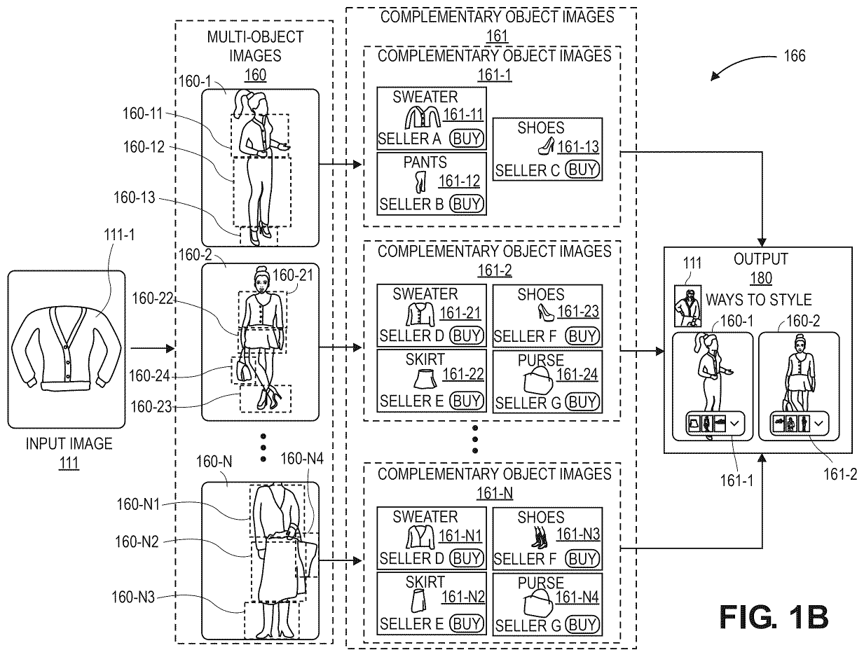

FIG. 1A is a block diagram illustrating a recommendation system 125 that generates one or more multi-object images and corresponding complementary object image recommendations, according to exemplary implementations of the present disclosure. FIG. 1B is a transition diagram 166 illustrating an example transition from an input image 111 to a plurality of multi-object images 160 and corresponding complementary object images 161, utilizing the recommendation system 125 discussed with respect to FIG. 1A, according to exemplary implementations of the present disclosure.

As illustrated in FIG. 1A, a recommendation system 125 receives an input image 111 from a client device 110. An input image 111 may be any form of image or other input data that includes a representation of an object, such as a product. The object represented in the input image is referred to herein as an “input object.” Turning briefly to FIG. 1B, as an example, the input image 111 is an image of a V-neck sweater. In this example, the V-neck sweater is referred to herein as an input object 111-1.

In some examples, the input image 111 may be limited to only images that include a representation of a single object. In other examples, the input image may include representations of multiple objects. In such cases, the recommendation system 125 determines a primary object from the multiple objects. For example, an object detector of the recommendation system 125 may process the input image to determine objects represented in the image, respective sizes of those objects, respective positions of those objects in the image, etc. The object detector, the recommendation system, and/or another component may then determine a primary object in the input image based on, for example, the size and position of the detected objects. For example, the recommendation system may determine the primary object as the object that is the largest, in the foreground, and the focus of the input image. In other examples, other techniques may be used to determine the primary object in an input image. The primary object, once determined is considered the input object. In addition, while the examples discussed below describe generating an input embedding for the input image, in examples in which the input image includes multiple objects, those objects may be segmented into individual object segments and the input embedding generated for the object segment that includes the primary object.

In still other examples, rather than selecting a primary object from multiple objects of an input image, the disclosed implementations may consider multiple objects included in the input image. For example, the disclosed implementations may determine multi-object images that include objects that are the same as or visually similar to the multiple objects of an input image. For example, if the input image includes a chair and a rug (objects), the disclosed implementations may determine multi-object images that contain the same or visually similar chair and rug to those included in the input image. In still other examples, more than one input image may be utilized with disclosed implementations.

While the example illustrated in FIG. 1A illustrates the client device as the source of the input image, in other implementations, the input image may be provided from another source. For example, the input image may be an image already maintained by the recommendation system 125, or by an entity, such as a social networking site, shopping platform, etc. In still other examples, the recommendation system 125 provides the input image 111 to the client device 110. For example, if a user submits a text-based query, the query may return an image of a black shirt. In such an example, the disclosed recommendation system 125 may use the image of the black shirt as the input image 111 and determine multi-object images, along with a set of complementary object images, and return those images with the image of the black shirt. In other examples, a user may select an image for presentation on a client device. In such an example, the recommendation system 125 may use the selected image as the input image 111. Accordingly, as will be appreciated, the input image 111 may be any type of image received from any of a variety of sources. A “set,” as used herein, refers to one or more. For example, a set of complementary object images may include one or more complementary object images.

Regardless of the source of the input image 111, the recommendation system 125 processes the input image 111 with an embedding generator 123 to produce an input image embedding 150 encoding features representative of the input image. The embedding generator 123 that generates the input image embeddings may be, for example, a deep neural network, such as convolutional neural network (“CNN”), that has been trained on a large data set to learn meaningful image representations. In some implementations, the recommendation system 125 may also generate an input image signature for the input image. The input image signature may be, for example, a hash value generated from the input image, or another unique identifier for the input image.

As is known, an embedding, such as an input image embedding and/or the other embeddings discussed herein, is a numerical representation of an image that preserves the key features, characteristics, and important information about the image in a fixed-length array of numbers. For example, an embedding may be a 512, 1024, or other length of floating point numbers that represent an image, such as an input image. As is known in the art, visually similar images will have similar embeddings that are close in distance with each other in an embedding space. Embeddings maintain semantic relationships, and mathematical operations can be performed on embeddings. As non-limiting examples, and as is known, embeddings of images of dogs will cluster together in the embedding space, as will embeddings of images of cats, tables, etc. Likewise, as discussed further below, mathematical operations may be performed with respect to embeddings, such as to determine distances between embeddings within the embedding space.

An embedding space is a highly-dimensional (e.g., hundreds or thousands of dimensions) mathematical space where each point of the embedding space represents an embedding. For example, a 512-dimensional embedding space means that each embedding has 512 coordinates. Each dimension represents a learned feature or attribute and distance between points in the embedding space represents semantic similarity of the image represented by the embeddings in the embedding space.

An image signature, as used herein, is a unique identifier of an image. For example, if the image signature is a hash value, the hash value uniquely identifies that image. As is known, a hash value for an image may be generated by applying a mathematical algorithm (hashing function) to the image data of the image. The hashing function generates a unique string or hash value that will be the same every time that image is processed by the hashing function.

Utilizing the input image embedding 150, a multi-object images determination component 126 determines one or more multi-object images. As discussed further below, the recommendation system 125 may curate and maintain a corpus of multi-object images and corresponding signatures in a multi-object images data store 151. As part of that curation and maintenance, the recommendation system 125, or another system, may segment objects represented in each of the multi-object images into object segments. The embedding generator 123 may generate, for each object segmented, an object embedding encoding features representative of the object included in the object segment. The recommendation system 125 may likewise maintain those object embeddings in an object embedding index 152, along with an association between the object embedding, the object segment, and the multi-object image from which the object was segmented. For example, if a multi-object image includes representations of four different objects, the recommendation system 125 may extract pixels of the multi-object image corresponding to each of those objects as separate object segments (i.e., one object segment for each of the objects represented in the multi-object image). The embedding generator 123 then processes each of those object segments to produce an object embedding encoding features representative of the object segment. Each of those object embeddings are then stored in the object embedding index 152. The association maintained in the object embedding index may be, for example, a key: value pair. In such an example, the index may be searchable by the object embedding, and the associated value may be a list containing one or more of the corresponding multi-object image signature, the XYWH coordinates of the object segment, and the category of the object.

To determine the one or more multi-object images 160, the multi-object images determination component 126 may determine one or more object embeddings of the object embedding index 152 that are the most similar to the input image embedding 150. For example, similarity scores may be determined for each object embedding based on a distance determined between the respective object embedding and the input image embedding. Any of a variety of techniques may be used to determine a distance between the input image embedding and each of the object embeddings, such as, but not limited to, a Euclidean distance, a cosine similarity, nearest neighbor, etc. The closer in distance the object embedding to the input image embedding in the embedding space, the higher the similarity score for the object embedding.

The multi-object images determination component 126 selects multi-object images 160 that are associated with object embeddings that are within a threshold distance of the input image embedding and/or have a similarity score that meets or exceeds a similarity score threshold. The threshold distance may be any defined distance or other measure of similarity. In other examples, the multi-object images determination component 126 may select a defined number of multi-object images (e.g., 10, 25, 50, 100, etc.) that are associated with object embeddings that are determined to be closest in distance to the input image embedding. As a result, the selected multi-object images 160 are images that are determined to include an object that is the same as or visually similar to the object represented in the input image 111, along with representations of other objects.

Turning again to the example discussed with respect to FIG. 1B, the input image embedding for the input image 111 is compared with object embeddings to determine, in this example, multi-object images 160-1, 160-2, through 160-N. In particular, multi-object image 160-1 is selected because the object 160-11 is determined to be visually similar to the input object 111-1. In this example, both the object 160-11 and the input object 111-1 are the same V-neck sweater. Multi-object image 160-2 is selected because the object 160-21 is determined to be visually similar to the input object. In this example, while not the same, both the object 160-21 and the input object 111-1 are V-neck sweaters. Multi-object image 160-N is selected because the object 160-N1 is determined to be visually similar to the input object 111-1. In this example, while not the same, both the object 160-N1 and the input object 111-1 are V-neck sweaters. As discussed, the similarity between the input object and the objects represented in the multi-object images 160-1, 160-2, through 160-N may be determined based on a distance in an embedding space between the input image embedding generated for the input image and each of the object embeddings generated for the respective object segments of the multi-object images. Alternatively, the multi-object images determination component 126 may determine similarity based on a similarity score computed for the object segments of the multi-object images, the similarity score indicative of a similarity between the object segments as determined by the distance between the respective object embeddings and the input image embedding.

As illustrated, while each of the selected multi-object images 160-1, 160-2, through 160-N include an object that is visually similar to the input object, each multi-object image also includes representations of other objects. For example, multi-object image 160-1 also includes representations of two other objects 160-12, 160-13 which, in this example, are pants and shoes, respectively. Multi-object image 160-2 includes representations of three other objects 160-22, 160-23, 160-24 which, in this example, are a skirt, shoes, and a handbag, respectively. Multi-object image 160-N includes representations of three other objects 160-N2, 160-N3, 160-N4 which, in this example, are a skirt, boots, and a handbag, respectively. As discussed further below, each multi-object image may include at least a defined number of objects. In some implementations, those objects must all correspond to the same category (e.g., clothing, home décor, automobiles, etc.). In other examples, some or all of the objects of a multi-object image may correspond to different categories.

Returning to FIG. 1A, in some implementations, the deduplication and ranking component 128 may deduplicate and/or rank the determined multi-object images 160. For example, the deduplication and ranking component 128 may deduplicate multi-object images by comparing multi-object embeddings corresponding to the multi-object images and eliminate multi-object images that are highly similar or duplicates of other multi-object images 160 determined by the multi-object images determination component 126. In other examples, deduplication may be done based on multi-object image signatures. For example, the deduplication and ranking component may deduplicate multi-object images by removing those multi-object images that have the same exact or near duplicate multi-object image signature as another multi-object image of the determined multi-object images.

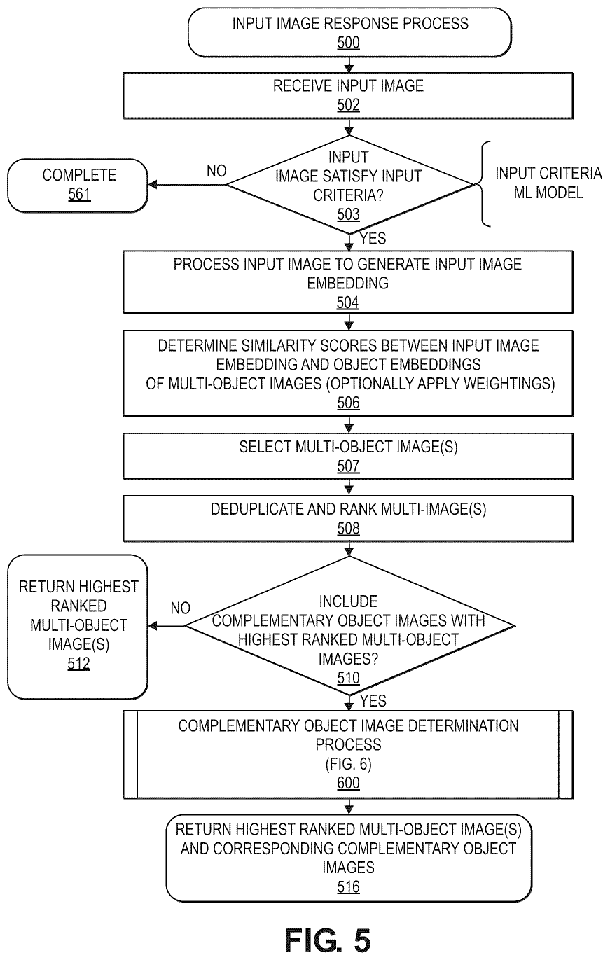

In addition to deduplication, in some examples, the deduplication and ranking component 128 may rank the multi-object images based on the similarity score/distance determined for the associated object embedding. In other examples, the deduplication and ranking component 128 may determine the highest ranked multi-object image as the multi-object image corresponding to the object embedding having the highest similarity score/closest distance to the input image embedding. In some cases, the other selected multi-object images may be reranked based on any of a number of ranking criteria. As will be appreciated, the deduplication and ranking component 128 may rank the selected multi-object images based on any of a number of ranking criteria. As discussed further below with respect to FIG. 5, ranking criteria may include, but is not limited to, the popularity of the multi-object image, the popularity of objects represented in the multi-object image, the number of objects represented in the multi-object image, the relationship between the objects represented in the multi-object images, whether a user to which the multi-object images are to be presented has seen or not seen the selected multi-object images, etc.

The deduplication and ranking component 128 outputs or provides the highest ranked one or more multi-object images to a complementary object image(s) determination component 127. The complementary object image(s) determination component 127 determines complementary object images of objects that are complementary to the input object, as determined by the relationship of those objects with objects included in the highest ranked multi-object images 160.

For example, the complementary object image(s) determination component 127, utilizing the object embeddings for each object represented in the highest ranked multi-object image(s), may determine one or more complementary object images for each object represented in each of the highest ranked multi-object images 160. As discussed herein, a corpus of complementary object images may be curated and maintained in a complementary object images data store 154. Likewise, and as also discussed herein, the embedding generator 123 may generate and maintain a corresponding complementary object embedding in a complementary object embedding index 153 for each of the complementary object images, along with an association between the complementary object embedding and the corresponding complementary object image.

Complementary object images may be single object images, such as product images. In some examples, the complementary object images may be associated with a seller (or sellers) of an object represented in the image and include or be presented with a control (buy button) that may be interacted with to initiate a purchase of the object represented in the complementary object image. Regardless, the embedding generator 123 may generate, for each complementary object image, a complementary object embedding encoding features representative of the complementary object image. Likewise, the recommendation system 125 may also generate and maintain a complementary object image signature for each complementary object image. The embedding generator 123 may associate the generated complementary object embedding with the corresponding complementary object image signature and maintain the association in the complementary object images embedding index 153.

The complementary object image(s) determination component 127 determines one or more complementary object embeddings from the complementary object embedding index 153 that are the most similar to an object embedding corresponding to an object represented in a selected multi-object image. For example, and as discussed further below, the complementary object image(s) determination component 127 may determine similarity scores for each complementary object embedding based on a distance between the respective complementary object embedding and the object embedding. Any of a variety of techniques may be used to determine a distance between the object embedding and each of the complementary object embeddings, such as, but not limited to, a Euclidean distance, a cosine similarity, nearest neighbor, etc. The closer the complementary object embedding to the object embedding in the embedding space, the higher the similarity score for the object embedding.

The complementary object image(s) determination component 127 selects one or more complementary object images from the complementary object images data store 154 that are associated with complementary object embeddings that are within a threshold distance of the object embedding and/or have a similarity score that meets or exceeds a similarity score threshold. This processing may be done for each object/object segment of each of the highest ranked multi-object images. As complementary object images are determined, the complementary object image(s) determination component 127, associates the complementary object image with the multi-object image corresponding to the compared object embedding. As a result, and because each multi-object image includes multiple objects/object segments, each multi-object image will have multiple associated complementary object images 161. Finally, the recommendation system 125 outputs 180 for presentation one or more of the highest ranked multi-object images and associated complementary object images. For example, the recommendation system 125 may output the highest ranked multi-object image and associated complementary object images for presentation on a display of the client device 110.

Referring again to the example discussed with respect to FIG. 1B, the complementary object image(s) determination component 127 processes each of the object embeddings associated with objects 160-11, 160-12, and 160-13 of multi-object image 160-1 and determines complementary object images 161-11, 161-12, and 161-13 as having a highest similarity, respectively, with each of those objects 160-11, 160-12, and 160-13 and associates those complementary object images 161-11, 161-12, 161-13 with the multi-object image 160-1. The complementary object image(s) determination component 127 processes each of the object embeddings associated with objects 160-21, 160-22, 160-23, and 160-24 of multi-object image 160-2 and determines complementary object images 161-21, 161-22, 161-23, and 161-24 as having a highest similarity, respectively, with each of those objects 160-21, 160-22, 160-23, and 160-24 and associates those complementary object images 161-21, 161-22, 161-23, 161-24 with the multi-object image 160-2. The complementary object image(s) determination component 127 processes each of the object embeddings associated with objects 160-N1, 160-N2, 160-N3, and 160-N4 of multi-object image 160-N and determines complementary object images 161-N1, 161-N2, 161-N3, and 161-N4 as having a highest similarity, respectively, with each of those objects 160-N1, 160-N2, 160-N3, and 160-N4 and associates those complementary object images 161-N1, 161-N2, 161-N3, 161-N4 with the multi-object image 160-N.

As discussed, the complementary object image(s) determination component 127 determines the similarity between each object segment of the multi-object images and the complementary object images based on a distance in an embedding space. Alternatively, the complementary object image(s) determination component 127 may determine the similarity between each object of the multi-object images and complementary object images based on a similarity score computed for the complementary object images. For example, the complementary object image(s) determination component 127 may compute a similarity score for each complementary object image based on a similarity between the complementary object image and the object segment of the multi-image object. In some examples, the similarity and corresponding similarity score is determined based on the distance between the respective embeddings corresponding to the complementary object image and the extracted object segment.

Finally, the recommendation system 125 generates an output 180 that, in the example illustrated with respect to FIG. 1B, includes the input image 111 and the two highest ranked multi-object images 160-1 and 160-2, along with the corresponding complementary object images 161-1, 161-2 determined for those multi-object images 160-1, 160-2. In the illustrated example, the complementary object images 161-1, 161-2 determined for each multi-object image 160-1, 160-2 are presented as a carousel that may be interacted with to rotate through and view the complementary object images corresponding to each multi-object image. In other examples, additional or fewer multi-object images may be included in the output 180, additional or fewer complementary object images may be included in the output, and the multi-object images and/or complementary object images may be presented differently.

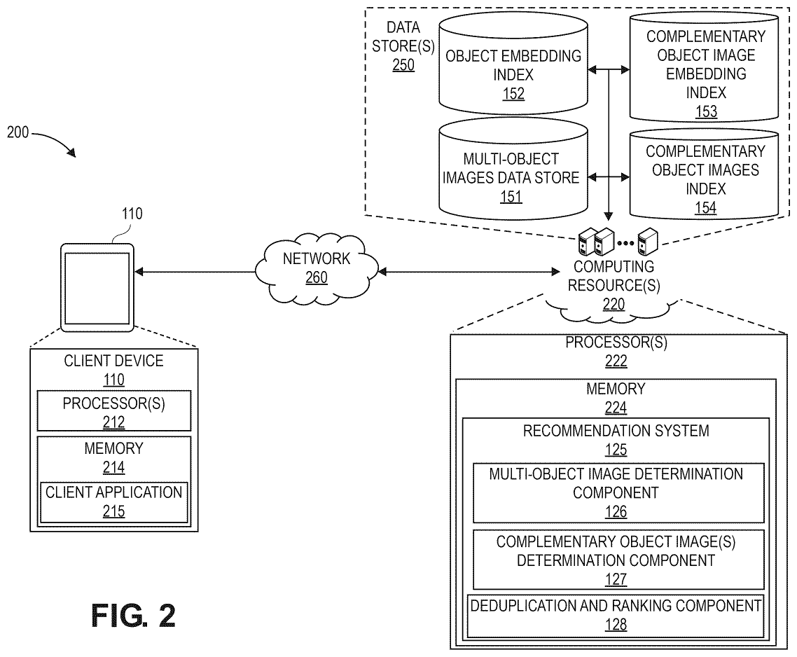

FIG. 2 is a block diagram illustrating an exemplary computing environment 200 that may be utilized or include the components discussed with respect to FIGS. 1A and 1B, according to exemplary implementations of the present disclosure.

As shown in FIG. 2, computing environment 200 may include one or more client devices 110, also referred to as user devices, for connecting over network 260 to access computing resources 220. Client device 110 may include any type of computing device, such as a smartphone, tablet, laptop computer, desktop computer, wearable, etc., and network 260 may include any wired or wireless network (e.g., the Internet, cellular, satellite, Bluetooth®, Wi-Fi®, etc.) that can facilitate communications between client device 210 and computing resources 220. The client device 110 may include one or more processors 212 and one or more memory 214, which may store one or more client applications 215, such as a web browser, social networking application, shopping application, etc.

Computing resources 220 may include one or more processor(s) 222 and one or more memory 224, which may store one or more applications, such as recommendation system 125, multi-object image determination component 126, complementary object image(s) determination component 127, deduplication and ranking component 128, embedding generation component, object detection component, etc., that may be executed by processor(s) 222 to cause processor(s) 222 of computing resources 220 to perform various functions and/or actions discussed herein. It is noted that computing environment 200 is a logical configuration and is not necessarily an actual configuration. Accordingly, there may be numerous ways in which computing environment 200 may be implemented, and FIG. 2 should be viewed as illustrative and not limiting.

According to aspects of the present disclosure, computing resources 220 may represent at least a portion of a networked computing system that may be configured to provide online applications, services, computing platforms, servers, and the like, such as a social networking service, social media platform, e-commerce platform, content recommendation systems, search services, shopping services, and the like, that may be configured to execute on a networked computing system. Further, computing resources 220 may communicate with one or more data store(s) 250, such as object embedding index 152, multi-object images data store 151, complementary object embedding index 153, and complementary object images data store 154, and/or other data stores, such as a user profile data store, user history data store, etc.

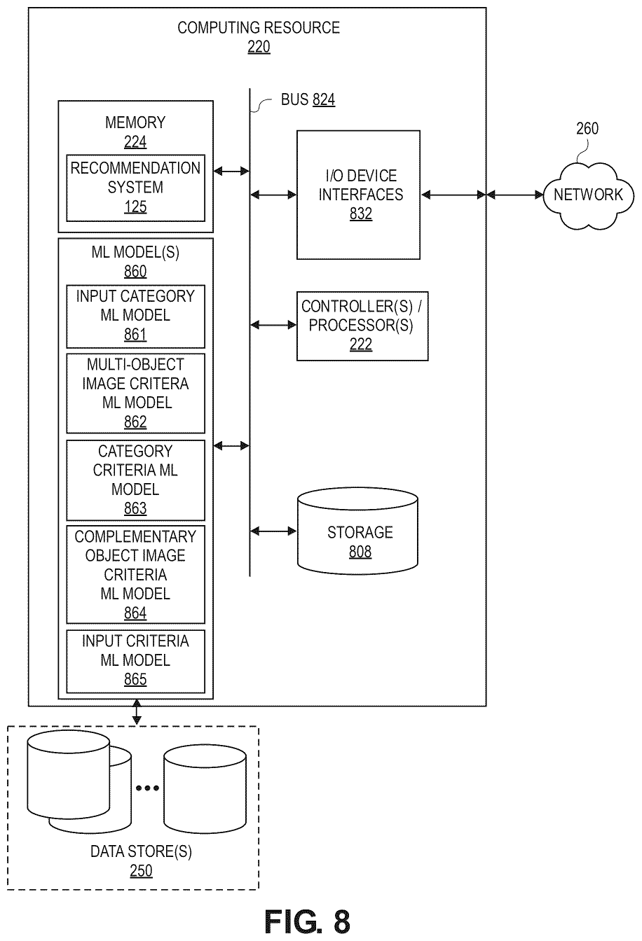

According to exemplary implementations of the present disclosure, computing resources 220 may be representative of computing resources that may form a portion of a larger networked computing platform (e.g., a cloud computing platform, and the like), which may be accessed by client device 110. Computing resources 220 may provide various services and/or resources and do not require end-user knowledge of the physical premises and configuration of the system that delivers the services. For example, computing resources 220 may include “on-demand computing platforms,” “software as a service (SaaS),” “infrastructure as a service (IaaS),” “platform as a service (PaaS),” “platform computing,” “network-accessible platforms,” “data centers,” “virtual computing platforms,” and so forth. As shown in FIG. 2, computing resources 220 may be configured to execute and/or provide a social media platform, a social networking service, a recommendation system, a search service, an e-commerce platform, or any other form of interactive computing. Example components of a remote computing resource, which may be used to implement computing resources 220, are discussed below with respect to FIG. 8.

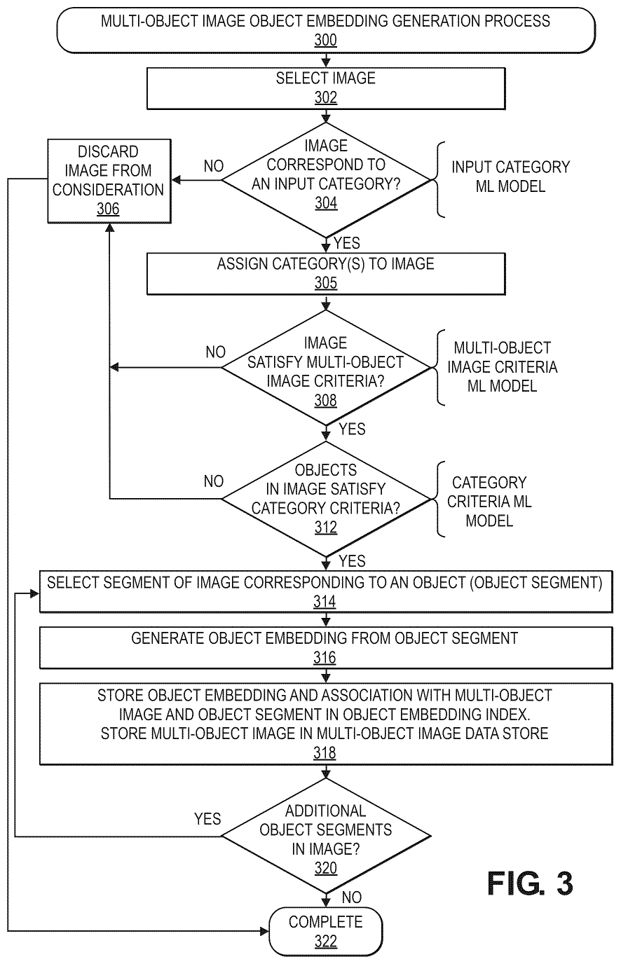

FIG. 3 is an example multi-object image embedding generation process 300, according to exemplary implementations of the present disclosure.

The example process 300 may be performed by the embedding generator 123 discussed above. In some implementations, the example process 300 may be performed periodically (e.g., nightly, weekly, monthly) and/or in real-time each time a new image is received or added to the recommendation system 125.

The example process 300 begins by selecting or receiving an image, as in 302. If the example process 300 is being performed periodically, it may select an image from a corpus of images accessible to the example process 300. For example, the example process 300 may randomly select an image from a corpus if the recommendation system is part of a social networking platform that maintains million or billions of images in a corpus. In other implementations, the example process 300 may only process images received from certain entities (e.g., sellers). While in other examples, the example process 300 may process any and all images that are accessible.

Upon selection of an image, a determination may be made as to whether the image corresponds to an input category, as in 304. An input category may be one of many categories for which the disclosed implementations may be utilized. A non-limiting example of input image categories includes, fashion, home décor, beauty, design, animals, Thanksgiving, food and drink, Do-It-Yourself (“DIY”), Christmas, and Weddings. As will be appreciated, any of a variety of categories may be specified and categories may be added and/or removed from consideration by the example process 300.

In some implementations, a machine learning (“ML”) model trained to process images and assign the image to one of a plurality of categories may determine whether the image corresponds to an input category. As discussed below, the ML model may be trained based on a training set of images that are labeled with different categories so that the ML model learns to assign an image to one of the plurality of categories. In some implementations, the ML model may be trained to select and output a single (or multiple) categories in response to processing an image. In other implementations, the ML model may be trained to output probability scores for each of the plurality of categories for which the ML model is trained, the probability score indicative of a probability that the image corresponds to the respective category. In other implementations, additional and/or other factors beyond analysis by an input category ML model may be considered in determining if the image corresponds to an input category. For example, some images may include metadata indicating a category of the image. As an example, a seller of a product represented in the image may assign metadata to the image indicating the category to which the image is to be assigned.

If it is determined that the image does not correspond to an input category, at 306, the example process 300 discards the image from consideration and completes for that image, as in 322. As noted above, the example process 300 may be performed numerous times, once for each image that is accessible to the example process 300. In other implementations, even if an image has previously been processed by the example process 300 it may be reprocessed to update information about the image—e.g., if additional categories have been added or removed.

If it is determined that the selected image does correspond to an input category, the example process 300 assigns the corresponding input category(s) to the image, as in 305. Additionally, the example process 300 determines whether the image satisfies a multi-object image criteria, as in 308. The multi-object image criteria may specify, for example, a number of objects that must exist in the image for it to be processed by the example process 300, whether those objects must all belong to the same category or different categories, etc. In some examples, a multi-object image criteria ML model may determine whether the image satisfies the multi-object image criteria. Such a multi-object image criteria ML model may be trained to determine if an input image complies with one or more specific multi-object image criteria. For example, the ML model may be trained based on a training set of images that are labeled with different criteria for multi-object images so that the ML model learns to determine whether the image satisfies the multi-object image criteria. In some implementations, the ML model may be trained to determine if the image includes a minimum number of unique objects (e.g., three or more objects), whether the minimum number of objects all correspond to the same category, whether there are less than a maximum number of objects in the image, and whether there are less than a maximum number of categories represented by objects in the image. In such an example, the ML model only determines that an input image satisfies the multi-object image criteria if all of the conditions are true (e.g., that there are more than the minimum number of objects in the image, that that minimum number of objects all correspond to the same category, that there are less than a maximum number of objects in the image, and that there are less than a maximum number of categories represented by objects in the image). As will be appreciated, the ML model may be trained to consider additional, fewer, or different criteria. Other example criteria may include, but are not limited to, each object being of a minimum size or percentage of the image, the image quality being above a minimum resolution, the image being a Red, Green, Blue (“RGB”) image, etc. In other implementations, the example process 300 may consider additional and/or other factors beyond analysis by a multi-object image criteria ML model in determining if the image satisfies the multi-object image criteria. For example, the example process 300 may consider metadata of an image to determine if the image satisfies the multi-object image criteria. Image metadata for an image may indicate, for example, the number of objects in the image, the categories corresponding to those objects, etc.

If the example process 300 determines that the image does not satisfy the multi-object image criteria, at 306, the image is discarded from consideration and the process 300 completes for that image, as in 322. If the example process 300 determines that the image does satisfy the multi-object image criteria, the example process 300 may further determine whether the objects represented in the image satisfy category criteria for the category to which the multi-image object is assigned, as in 312. A category criteria ML model may be trained to determine if the image satisfies the category criteria. In some implementations, different ML models may be trained for different categories. In other implementations, a single ML model may be trained and the category for the image may be included as an input to the ML model to guide the model toward a result for that category. Example category criteria include, for example, the distance between objects in the image that correspond to the same category, the size of the objects in the image corresponding to the category with respect to other objects in the image, whether the objects corresponding to the category are in the foreground or background of the image, etc. If the example process 300 determines that the image does not satisfy the category criteria, at 306, the selected image is discarded from consideration, and the example process 300 completes for that image, as in 322.

In some implementations, the determinations discussed with respect to decision blocks 304, 308, and 312 may be optional and/or one or more of the determinations may be combined.

Returning to decision block 312, if the example process 300 determines that the image does satisfy the category criteria, a segment of the image corresponding to an object in the image, referred to herein as an object segment, is selected, as in 314. In some examples, an image processing ML model or other image processing algorithm may be used to process the image, determine objects in the image, and define bounding boxes that encompass pixels corresponding to those objects. In such an example, the bounding box and the encompassed pixels may be extracted as the object segment of the object from the multi-object image. For example, a You Only Look Once (“YOLO”) model, Detection Transformer (“DETR”), Co-DETR, etc., alone or in combination may be used by the disclosed implementations to detect and segment objects into object segments. In some implementations, the object segment generation may be performed as part of processing the image to determine a number and/or type of objects in the image. For example, the multi-object image criteria ML model may be trained to generate object segments as part of determining the number and/or category for objects represented in the image.

An object embedding may then be generated, for example using the embedding generator 123 discussed above, that corresponds to the object segment, as in 316. The example process 300 then associates the object embedding with the multi-object image from which the object segment was extracted and/or with the object segment used to generate the object embedding, as in 318. Likewise, the example process 300 may store the associations and/or the object embedding in the object embedding index 152. In some implementations, the object embedding may be associated with the multi-object image signature as a key: value pair and the association stored in the object embedding index 152. In addition, the example process 300 may store the multi-object image in the multi-object image data store 151 as part of the corpus of multi-object images.

By maintaining an indexed association between the object embedding and the multi-object image signature of the multi-object image from which the object was extracted, the multi-object image can be determined/obtained directly from the association with the object embedding, as discussed herein.

The example process 300 may then determine whether additional object segments of the multi-object image remain to be processed, as in 320. If the example process 300 determines that additional object segments of the multi-object image remain to be processed, the example process 300 returns to decision block 314, selects a next object embedding of the multi-object image, and continues. If the example process 300 determines that no additional object segments of the multi-object image remain for processing, the example process 300 completes for that image, as in 322.

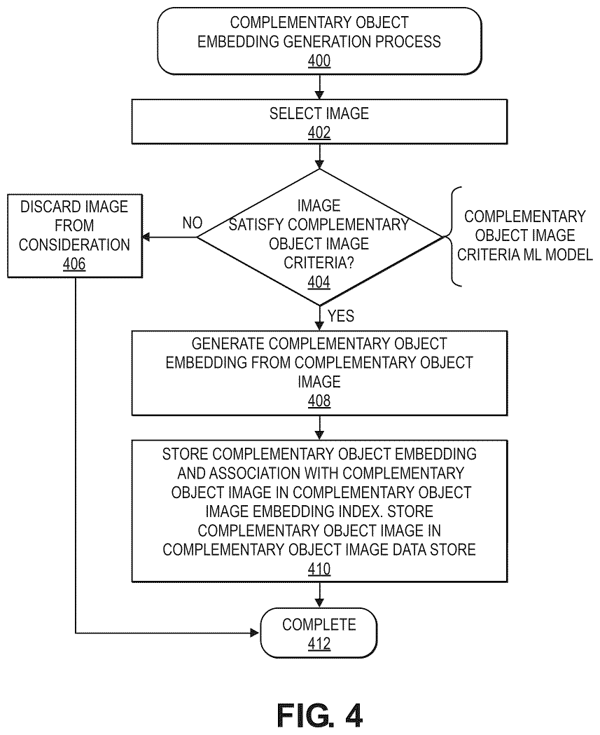

FIG. 4 is an example complementary object embedding generation process 400, according to exemplary implementations of the present disclosure. The example process 400 may be performed by the embedding generator 123 discussed above. In some implementations, the example process 400 may be performed periodically (e.g., nightly, weekly, monthly) and/or in real-time each time a new image is received or added to the recommendation system 125.

The example process 400 begins by selecting or receiving an image, as in 402. If the example process 400 is being performed periodically, it may select an image from a corpus of images accessible to the example process. For example, if the recommendation system is part of a social networking platform that maintains million or billions of images in a corpus, the example process may randomly select an image from the corpus. In other implementations, the example process may only process images received from certain entities (e.g., sellers). While in other examples, the example process may process any and all images that are accessible.

Upon selection of an image, the example process 400 determines whether the image satisfies a complementary object image criteria, as in 404. The complementary object image criteria may include or specify any one or more conditions/criteria that must be satisfied for the image to be processed by the example process and included as a complementary object image. Example criteria may include, but are not limited to, the image only including a single object, the image being associated with or linked to a seller of an object represented in the image, the image being of a minimum size and/or quality, the image being a color image, etc. In some implementations, a category of the object represented in the image may also be determined and used as a criteria and/or associated with the image.

In some implementations, an ML model may determine whether the image satisfies the one or more complementary object image criteria. For example, an ML model trained to process images and determine if those images satisfy the complementary object image criteria may be used to determine whether the image satisfies one or more complementary object image criteria. As discussed below, the ML model may be trained based on a training set of images that are labeled with different complementary object image criteria and whether those images comply with those criteria. In some implementations, the ML model may be trained to output a binary response (yes/no) as to whether the image complies with the complementary object image criteria. In other implementations, the ML model may be trained to output probability scores for each criterion of the complementary object image criteria for which the ML model is trained, the probability score indicative of a probability that the image satisfies or does not satisfy the respective criterion. In other implementations, the example process 400 may consider additional and/or other factors beyond analysis by an ML model in determining if the image satisfies the complementary object image criteria. For example, the example process 400 may consider image metadata in determining whether the image satisfies the complementary object image criteria. Image metadata may indicate or include, for example, whether image is intended to be a complementary object image for a particular object, a seller of the object, a link to a webpage of a seller of the object, etc.

If the example process 400 determines that the image does not satisfy the complementary object image criteria, at 406, the example process 400 discards the image from consideration and completes for that image, as in 412. As noted above, the example process 400 may be performed numerous times, once for each image that is accessible to the example process 400 or otherwise provided to the example process 400.

If the example process 400 determines that the image does satisfy the complementary object image criteria, the example process 400 generates a complementary object embedding, for example using the embedding generator 123 discussed above, that corresponds to the complementary object image, as in 408. The complementary object embedding may then be associated with the complementary object image and the complementary object embedding and the association stored in the complementary object embedding index, as in 410. In some implementations, the complementary object embedding may be associated with the complementary object image signature as a key: value pair and the association stored in the complementary object embedding index. Likewise, the complementary object image may be stored in the complementary object data store as part of the corpus of complementary object images.

By maintaining an association between the complementary object embedding and the complementary object image signature, the complementary object image can be determined/obtained directly from the association with the complementary object embedding. The example process 400 then completes for that image, as in 412.

FIG. 5 is an example input image response process 500, according to exemplary implementations of the present disclosure. The example process 500 may be performed by the recommendation system 125 in real-time or near real-time as multi-object images and corresponding complementary object images are to be determined and provided for an input image.

The example process 500 begins upon receipt of an input image, as in 502. As discussed above, the input image may be any form of image or other input data that includes a representation of an input object. In some examples, the input image may be limited to only images that include a representation of a single object. In other examples, the input image may include representations of multiple objects and a primary object, also referred to herein as an input object, may be determined from the multiple objects represented in the input image. Likewise, the input image may be received from a client device 110, as illustrated in FIG. 1A, or may be an image provided from another source. For example, the input image may be an image already maintained by the recommendation system and/or an entity (e.g., social networking site, shopping platform, etc.) that is utilizing the recommendation system. In still other examples, the input image may be an image that is to be returned to the client device as responsive to another search submitted to the recommendation system by the client device. For example, if a user submits a text-based query, the query may return an image of a black shirt. In such an example, the example process 500 may use the image of the black shirt as the input image and determine multi-object images, along with a set of complementary object images, and return those images with the image of the black shirt. In other examples, a user may select an image for presentation on a client device. In such an example, the example process 500 may use the selected image as the input image. Accordingly, as will be appreciated, the input image may be any type of image received from any of a variety of sources.

Upon receipt of an input image, the example process 500 determines whether the input image satisfies an input criteria, as in 503. The input criteria may include or specify any one or more conditions/criteria that must be satisfied for the image to be processed by the example process 500. Example criteria may include, but are not limited to, the image only including a single object, the object corresponding to an input category, the image being associated with or linked to a seller of an object represented in the image, the image being of a minimum size and/or quality, the image being a color image, etc. Similar to input image categories determined for multi-object images, input image categories may include, but are not limited to fashion, home décor, beauty, design, animals, Thanksgiving, food and drink, DIY, Christmas, and Weddings.

In some implementations, determining whether the image satisfies the one or more complementary object image criteria may be determined by an ML model trained to process input images and determine if those input images satisfy the input criteria. As discussed below, the ML model may be trained based on a training set of images that are labeled with different input criteria and whether those images comply with those criteria. In some implementations, the ML model may be trained to output a binary response (yes/no) as to whether the image complies with the input criteria. In other implementations, the ML model may be trained to output probability scores for each criterion of the input criteria for which the ML model is trained, the probability score indicative of a probability that the image satisfies or does not satisfy the respective criterion. In other implementations, additional and/or other factors beyond analysis by an input criteria ML model may be considered in determining if the image satisfies the complementary object image criteria. For example, the image may include metadata that indicates the category to which the image relates and/or the image may be processed before step 503 to determine the category to which the image relates.

If the example process 500 determines that the image does not satisfy the input criteria, the example process 500 completes, as in 561. If the example process 500 determines that the image does satisfy the input criteria, the example process 500 processes the input image to generate an input image embedding, as in 504. For example, the embedding generator 123 discussed above may process the input image to generate an input image embedding.

The example process 500 then compares the input image embedding with some or all of the object embeddings maintained in the object embedding index to determine similarity scores for the object embeddings with respect to the input image embedding, as in 506. As discussed above, for example with respect to FIG. 3, multi-object images may be segmented and object embeddings generated for each of the segments and those object embeddings maintained in an object embedding index. By comparing the input image embedding with object embeddings of the object embedding index, multi-object images that include an object that is the same as or visually similar to the input object may be determined. For example, the multi-object images determination component 126 of the recommendation system 125 may determine similarity scores for each object embedding based on a distance between the respective object embedding and the input image embedding. Any of a variety of techniques may be used to determine a distance between the input image embedding and each of the object embeddings, such as, but not limited to, a Euclidean distance, a cosine similarity, nearest neighbor, etc. The closer the object embedding to the input image embedding in the embedding space, the higher the similarity score for the object embedding.

In some implementations, the example process 500 may also apply a weighting to the similarity scores as part of the similarity score determination. Alternatively, or in addition thereto, the example process may adjust the similarity scores, once determined, based on one or more weighting factors. For example, in some implementations, the example process 500 may compare all object embeddings with the input image embedding, but assign a higher weight to object embeddings corresponding to a same or similar category as the input image embedding. In other examples, the example process 500 may adjust the similarity score and/or weighting based on a user preference, a user history, a popularity of the objects represented by the object embeddings, etc.

The example process 500 then selects one or more multi-object images based at least in part on the similarity scores determined for the object embeddings, as in 507. For example, the multi-object images determination component 126 of the recommendation system 125 may select multi-object images as those multi-object images of the multi-object images data store that are associated with object embeddings that are within a threshold distance of the input image embedding. Additionally, or alternatively, the multi-object image determination component 126 may select multi-object images as those multi-object images having a similarity score that meets or exceeds a similarity score threshold. In still other examples, the multi-object images determination component 126 may select a defined number of multi-object images (e.g., 10, 25, 50, 100, etc.) that are associated with object embeddings that are determined to be closest in distance to the input image embedding. As a result, the selected multi-object images are images that are determined to include an object that is visually similar to the object represented in the input image, along with representations of other objects.

In some implementations, the example process 500 may also deduplicate and/or rank the selected multi-object images, as in 508. For example, the deduplication and ranking component 128 of the recommendation system 125 may compare the selected multi-object images to determine, duplicate, or near-duplicate multi-object images and only retain or keep one of the duplicate or near duplicate multi-object images. In one example, the deduplication and ranking component 128 may determine duplicate or near duplicate multi-object images by comparing multi-object embeddings corresponding to the entire multi-object image. Those multi-object embeddings that are within a threshold distance of each other may be identified as duplicates or near duplicates and deduplicated.

In addition to deduplication, in some examples, the example process 500 may rank the multi-object images based on the similarity score/distance determined for the associated object embedding and/or other factors. In other examples, the example process 500 may set as the highest ranked multi-object image, the multi-object image associated with the object embedding having the highest similarity score/closest distance to the input image embedding. Optionally, the example process 500 may re-rank the other selected multi-object images based on any of a number of ranking criteria. In still other examples, the example process 500 may re-rank all of the selected multi-object images based on any of a number of ranking criteria. Ranking criteria may include, but is not limited to, the popularity of the multi-object image and/or the popularity of objects represented in the multi-object image, the number of objects represented in the multi-object image, the relationship between the objects represented in the multi-object images, whether a user to which the multi-object images are to be presented has seen or not seen the selected multi-object images, etc.

After deduplicating and ranking the multi-object images, the example process 500 may determine whether to include complementary object images with the highest ranked multi-object images, as in 510. In some implementations, the example process 500 may determine that only the highest ranked multi-object images are to be returned for the input image. Such a determination may be made, for example, based on a user preference, based on the size or type of client device upon which the images are to be presented, etc. For example, if the results of the example process are to be presented on a client device with a small display, the example process 500 may determine that only the multi-object images are to be returned by the example process.

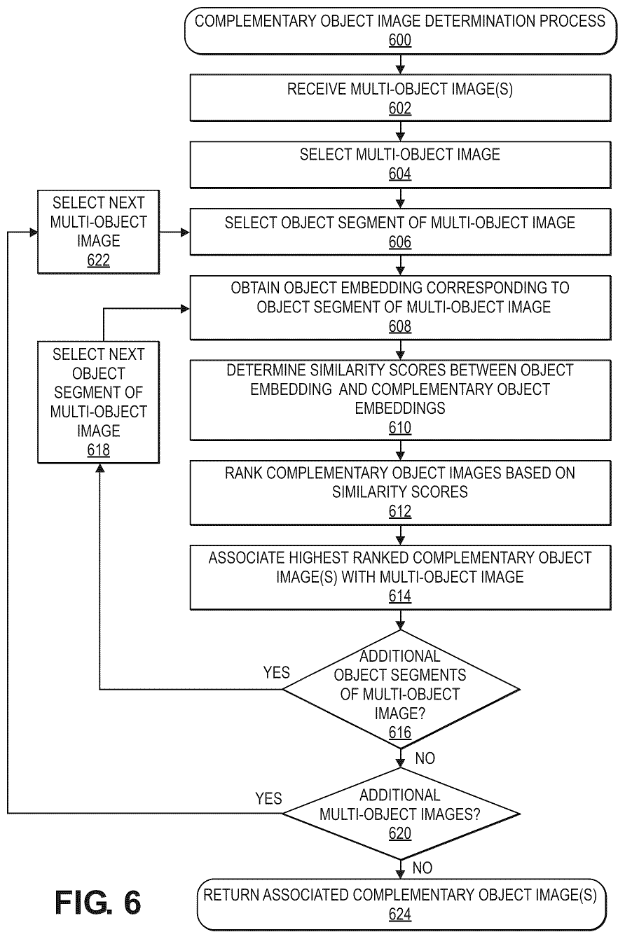

If the example process 500 determines that complementary object images are not to be included with the highest ranked multi-object images, the highest ranked multi-object images are returned as responsive to the input image, as in 512. However, if the example process 500 determines that complementary object images are to be included with the highest ranked multi-object images, the complementary object image determination process 600 is performed to determine one or more complementary object images to include with the highest ranked multi-object images. The complementary object image determination process 600 is discussed further below with respect to FIG. 6.

The highest ranked multi-object images may refer to only the single highest ranked multi-object image, a defined number of multi-object images having the highest rankings (e.g., the top 5, 10, 15 multi-object images), etc. Alternatively, in some implementations, the highest ranked multi-object images may include all of the multi-object images determined to include an object that is visually similar to the input object, as discussed above.

Upon receipt from the example process 600 of the complementary object images for each of the one or more highest ranked multi-object images, the example process returns or presents the one or more highest ranked multi-object images and corresponding complementary object images as responsive to the input image, as in 516.

FIG. 6 is an example complementary object image determination process 600, according to exemplary implementations of the present disclosure.

The example process 600 begins upon receipt of one or more multi-object images, as in 602. For example, the one or more highest ranked multi-object images determined as part of the example process 500 may be provided to the example process 600 for determination of complementary object images.

Upon receipt of the one or more multi-object images, the example process 600 selects a multi-object image of the one or more received multi-object images, as in 604, and selects an object segment of the multi-object image, as in 606. As discussed above, each multi-object image may be segmented such that each object represented in the multi-object image corresponds to an object segment of the multi-object image and an object embedding generated and stored for each object segment of the multi-object image.

For the selected object segment of the multi-object image, the example process 600 obtains the corresponding generated object embedding, as in 608. For example, and as discussed above, as object embeddings are generated for object segments of multi-object images, those object embeddings may be associated with the object segment and the multi-object image. Likewise, the associations and object embeddings may be maintained in an object embedding index.

The example process 600 then determines similarity scores for one or more of the complementary object embeddings maintained in the complementary object embedding index, as in 610. For example, the example process 600 may compare the obtained object embedding with a complementary object embedding and determine a similarity score for that complementary object embedding based on a distance between the two embeddings.

Similar to comparing an input image embedding with object embeddings, as discussed above, the example process 600 may determine a similarity score for each complementary object embedding based on a distance between the respective complementary object embedding and the object embedding. Any of a variety of techniques may be used to determine a distance between the object embedding and each of the complementary object embeddings, such as, but not limited to, a Euclidean distance, a cosine similarity, nearest neighbor, etc. The closer the complementary object embedding to the object embedding in the embedding space, the higher the similarity score for the complementary object embedding and corresponding complementary object image.

The example process 600 may then rank the complementary object images corresponding to the complementary object embeddings based on the similarity scores determined for those complementary object images, as in 612. Finally, the example process 600 may associate the highest ranked complementary object image(s) with the selected multi-object image, as in 614. In some implementations, only the highest ranked complementary object image may be associated with the multi-object image. In other examples, a defined number or set of the highest ranked complementary object images determined for the object segment of the multi-object image may be associated with the multi-object image.

The example process 600 may then determine whether additional object segments of the selected multi-object image remain for which complementary object images are to be determined, as in 616. If the example process 600 determines that additional object segments of the multi-object image remain, the example process 600 selects a next object segment of the selected multi-object image, as in 618, returns to block 608, and continues for that next selected object segment.

If the example process 600 determines that no additional object segments of the selected multi-object image remain for which complementary object images are to be determined, the example process 600 determines whether additional multi-object images received by the example process 600 remain for which complementary object images are to be determined and associated, as in 620. If the example process 600 determines that additional multi-object images remain for which complementary object images are to be determined, the example process 600 selects a next multi-object image, as in 622, returns to block 606, and continues for that next multi-object image.

If the example process 600 determines at decision block 620 that no additional multi-object images received by the example process 600 remain for which complementary object images are to be determined, at 624, the example process 600 returns, for each multi-object image received by the example process, the one or more complementary object images determined for each of the object segments of those multi-object images. Because each multi-object image includes more than one object segment, the example process 600 will determine and associate/return multiple complementary object images for each multi-object image. At a minimum, at least two complementary object images will be associated with a multi-object image as each multi-object image will include at least two objects and at least one complementary object image will be determined for each of the two objects.

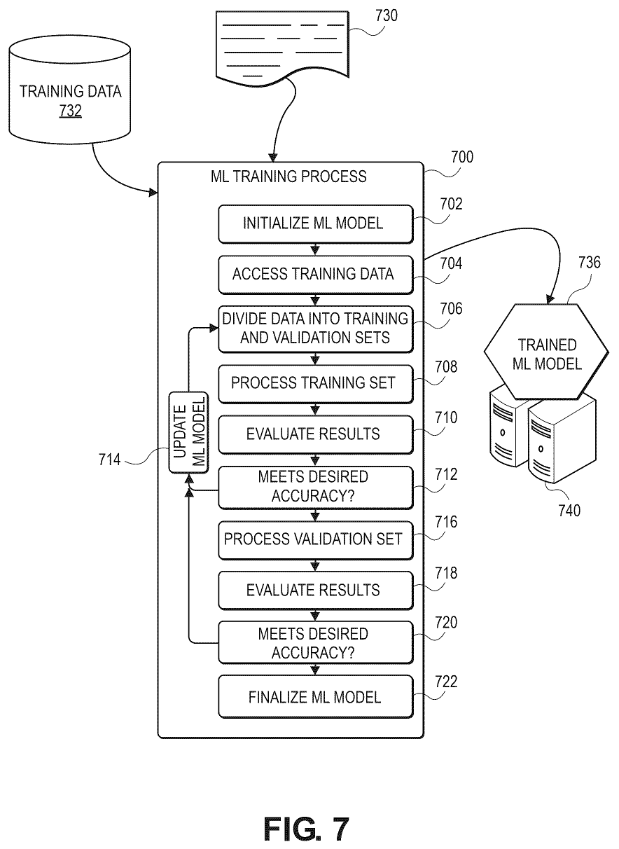

FIG. 7 is a flow diagram of an exemplary training process 700 for training an example ML model, such as a CNN, that may be used to generated image embeddings, an input category ML model, a multi-object image criteria ML model, a category criteria ML model, a complementary object image criteria ML model, input criteria ML model, etc., according to exemplary implementations of the present disclosure.

As shown in FIG. 7, training process 700 is configured to train an ML model operating on computer system 740 to transform the ML model into a trained ML model 736 that operates on the same or another computer system, such as computing resource 220. In the course of training, as shown in FIG. 7, at step 702, the ML model is initialized with training criteria 730. Training criteria 730 may include, but is not limited to, information as to a type of training, and number of layers to be trained, etc. For example, if the ML model is being trained to generate embeddings encoding features representative of images or object segments, the training criteria may specify the length of the embeddings, the type and form of input to be received and processed, the number of layers of the ML model to be trained, etc. As another example, if the ML model is being trained to be an input category ML model, a multi-object image criteria ML model, a category criteria ML model, a complementary object image criteria ML model, an input criteria ML model, etc., the training criteria may specify the number of layers to be trained, the structure and/or form of the output to be produced (e.g., binary output, probability output, etc.), the number, type and forms of inputs to be received and processed, etc.

At step 704 of training process 700, a corpus of training data 732, may be accessed. For example, if training is to generate a trained input criteria ML model that determines whether an input image is to be used in determining/providing one or more multi-object images and corresponding complementary object images, training data 732 may include example input images and labels indicating the satisfaction or dissatisfaction of each input criteria that the ML model is being trained to consider.

With training data 732 accessed, at step 706, training data 732 is divided into training and validation sets. Generally speaking, the items of data in the training set are used to train an ML model and the items of data in the validation set are used to validate the training of the ML model. As those skilled in the art will appreciate, and as described below in regard to much of the remainder of training process 700, there are numerous iterations of training and validation that occur during the training of the ML model.

At step 708 of training process 700, the data items of the training set are processed, often in an iterative manner. Processing the data items of the training set includes capturing the processed results. After processing the items of the training set, at step 710, the aggregated results of processing the training set are evaluated, and at step 712, a determination is made as to whether a desired accuracy level has been achieved. If the desired accuracy level is not achieved, in step 714, aspects, such as loss functions, weights, etc., of the machine learning model are updated in an effort to guide the machine learning model to generate more accurate results, and processing returns to step 706, where a new set of training data is selected, and the process repeats. Alternatively, if the desired accuracy level is achieved, training process 700 advances to step 716.

At step 716, and much like step 708, the data items of the validation set are processed, and at step 718, the processing accuracy of this validation set is aggregated and evaluated. At step 720, a determination is made as to whether a desired accuracy level, in processing the validation set, has been achieved. If the desired accuracy level is not achieved, in step 714, aspects of the machine learning model are updated in an effort to guide the machine learning model to generate more accurate results, and processing returns to step 706. Alternatively, if the desired accuracy level is achieved, the training process 700 advances to step 722.

At step 722, a finalized, trained ML model 736 is generated. Typically, though not exclusively, as part of finalizing the now-trained ML model 736, portions of the ML model that are included in the model during training for training purposes are extracted, thereby generating a more efficient trained ML model 736.

FIG. 8 is a block diagram illustrating an exemplary computing resource 220, according to exemplary implementations of the present disclosure.

In exemplary implementations, multiple such computing resources 220 may be included in the system. Further, it is noted that computing resource 220 is a logical configuration and is not necessarily an actual configuration. Indeed, there may be numerous ways in which computing resource 220 may be implemented, and FIG. 8 should be viewed as illustrative and not limiting. In operation, each of these devices (or groups of devices) may include computer-readable and computer-executable instructions that reside on computing resource 220, as will be discussed further below.

Computing resource 220 may include one or more controllers/processors 222, that may each include one or more central processing units (“CPU”) and/or graphics processing units (“GPU”) for processing data and computer-readable instructions, and memory 224 for storing data and instructions. Memory 224 may individually include volatile RAM, non-volatile ROM, non-volatile MRAM, and/or other types of memory. Computing resource 220 may also include a data storage component 808 for storing data, user actions, content items, user information, user history, content information, other supplemental information, etc. Each data storage component may individually include one or more non-volatile storage types such as magnetic storage, optical storage, solid-state storage, etc. Computing resource 220 may also be connected to removable or external non-volatile memory and/or storage (such as a removable memory card, memory key drive, networked storage, etc.) through input/output device interfaces 832. For example, the computing resources 220 may be connected to and store/retrieve data from data stores 250, such as the object embedding index data store 152, multi-object images data store 151, complementary object images embedding index 153, complementary object images data store 154, etc.

Computer instructions for operating computing resource 220 and its various components may be executed by the controller(s)/processor(s) 222, using memory 224 as temporary “working” storage at runtime. The computer instructions may be stored in a non-transitory manner in non-volatile memory 224, storage 808, or an external device(s). Alternatively, some or all of the executable instructions may be embedded in hardware or firmware on computing resource 220 in addition to or instead of software.

For example, memory 224 may store program instructions that when executed by the controller(s)/processor(s) 222 cause the controller(s)/processors 222 to execute the recommendation system 125 discussed herein, generate embeddings, execute one or more ML models 860, such as the input category ML model 861, the multi-object image criteria ML model 862, the category criteria ML model 863, the complementary object image criteria ML model 864, the input criteria ML model 865, etc.

Computing resource 220 also includes input/output device interface 832 that connects the computing resource 220 with one or more networks 260, such as the Internet. A variety of components may be connected through input/output device interface 832. Additionally, computing resource 220 may include address/data bus 824 for conveying data among components of computing resource 220. Each component within computing resource 220 may also be directly connected to other components in addition to (or instead of) being connected to other components across bus 824.

The disclosed implementations discussed herein may be performed on one or more computing resources, such as computing resource 220 discussed with respect to FIG. 8 or performed on a combination of one or more computing resources. Further, the components of the computing resource 220, as illustrated in FIG. 8, are exemplary, and may be located as a stand-alone device or may be included, in whole or in part, as a component of a larger device or system.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Persons having ordinary skill in the field of computers, communications, image processing, and machine learning should recognize that components and process steps described herein may be interchangeable with other components or steps, or combinations of components or steps, and still achieve the benefits and advantages of the present disclosure. Moreover, it should be apparent to one skilled in the art that the disclosure may be practiced without some, or all of the specific details and steps disclosed herein and/or that some steps or components discussed herein may be performed serially or in parallel.

Aspects of the disclosed system may be implemented as a computer method or as an article of manufacture such as a memory device or non-transitory computer-readable storage medium. The computer-readable storage medium may be readable by a computer and may comprise instructions for causing a computer or other device to perform processes described in the present disclosure. The computer-readable storage media may be implemented by a volatile computer memory, non-volatile computer memory, hard drive, solid-state memory, flash drive, removable disk, virtual drive, and/or other media.

The data and/or computer-executable instructions, programs, firmware, software and the like (also referred to herein as “computer-executable” components) described herein may be stored on a computer-readable medium that is within or accessible by computers or computer components such as computing resource 220, client device 110, or to any other computers or control systems, and having sequences of instructions which, when executed by one or more processors (e.g., CPU, GPU), cause the one or more processors to perform all or a portion of the functions, services, systems, and/or methods described herein. Such computer-executable instructions, programs, software and the like may be loaded into the memory of one or more computers using a drive mechanism associated with the computer readable medium, such as a floppy drive, CD-ROM drive, DVD-ROM drive, network interface, or the like, or via external connections.

Some implementations of the systems and methods of the present disclosure may also be provided as a computer-executable program product including a non-transitory machine-readable storage medium having stored thereon instructions (in compressed or uncompressed form) that may be used to program a computer (or other electronic device) to perform processes or methods described herein. The machine-readable storage media of the present disclosure may include, but is not limited to, hard drives, floppy diskettes, optical disks, CD-ROMs, DVDs, ROMs, RAMs, erasable programmable ROMs (“EPROM”), electrically erasable programmable ROMs (“EEPROM”), flash memory, magnetic or optical cards, solid-state memory devices, virtual drives, remote drives, or other types of media/machine-readable medium that may be suitable for storing electronic instructions. Further, implementations may also be provided as a computer-executable program product that includes a transitory machine-readable signal (in compressed or uncompressed form).

As used herein, the terms “product,” “item,” “object,” or like terms, may be used to refer to any good or service associated with a brand, and which may be depicted or referenced in one or more visual assets or audio content, or may be the subject of one or more advertisement creatives or other creative works. For example, products, items, or objects may include commercial goods, e.g., tangible objects that may be bought or sold, such as automobiles, books, clothing, computers, furniture, luggage, or others, as well as services, e.g., business services, social services, or personal services, such as travel, cruises, hair salons, personal training, legal or accounting services, or others.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow chart shown in FIGS. 3 through 7, orders in which such methods or processes are presented are not intended to be construed as any limitation on the claimed inventions, and any number of the method or process steps or boxes described herein can be combined in any order and/or in parallel to implement the methods or processes described herein. Additionally, it should be appreciated that the detailed description is set forth with reference to the accompanying drawings, which are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed is:

1. A computing system, comprising:
one or more processors; and
a memory storing program instructions that, when executed by the one or more processors, cause the one or more processors to at least:
receive an image that includes a representation of an object;
generate, based at least in part on the image, a first embedding encoding features representative of the image;
determine, based at least in part on the first embedding, a plurality of multi-object images, each of the plurality of multi-object images including multiple objects, at least one of the multiple objects corresponding to a first object embedding that is within a first threshold distance of the first embedding;
determine, for a first multi-object image of the plurality of multi-object images, a set of complementary object images, each complementary object image of the set of complementary object images corresponding to an object embedding that is within a second threshold distance of at least one object embedding corresponding to an object of the multiple objects included in the first multi-object image; and
present the first multi-object image and at least one complementary object image from the set of complementary object images.

2. The computing system of claim 1, further comprising:
a multi-object image data store that includes a corpus of multi-object images, including the plurality of multi-object images;
an object embedding index that includes, for each object represented in a multi-object image of the corpus of multi-object images, an object embedding corresponding to the object; and
wherein the program instructions that, when executed by the one or more processors to cause the one or more processors to determine the plurality of multi-object images, further include program instructions that cause the one or more processors to at least:
compare the first embedding with at least some of the object embeddings of the object embedding index to determine a plurality of object embeddings that are within the first threshold distance of the first embedding; and
selecting, from the corpus, the plurality of multi-object images that include an object corresponding to an object embedding of the plurality of object embeddings.

3. The computing system of claim 1, wherein the program instructions that, when executed by the one or more processors, further cause the one or more processors to at least:
rank the plurality of multi-object images based at least in part on a distance between the first embedding and an object embedding of each multi-object image, and
wherein the first multi-object image is a highest ranked multi-object image of the plurality of multi-object images.

4. The computing system of claim 1, wherein:
the at least one complementary object image is associated with a seller of an object represented in the at least one complementary object image; and
the program instructions that, when executed by the one or more processors to present the first multi-object image and the at least one complementary object image, further include program instructions that cause the one or more processors to at least:
present, with the at least one complementary object image, a control that may be interacted with to initiate a purchase of the object included in the complementary object image from the seller.

5. The computing system of claim 1, wherein:
the program instructions that, when executed by the one or more processors, further include program instructions that cause the one or more processors to at least:
determine a category corresponding to an object represented in the image; and
select a subset of a corpus of multi-object images such that the subset corresponds to the category; and
wherein the program instructions that, when executed by the one or more processors to determine the plurality of multi-object images, further cause the one or more processors to at least:
determine, based at least in part on the first embedding and the subset of the corpus, the plurality of multi-object images.

6. A computer-implemented method, comprising:
obtaining an input image that includes a representation of an input object;
generating a first embedding encoding features representative of the input image;
determining a multi-object image that includes a plurality of objects, at least one of the plurality of objects corresponding to an object embedding that is within a first threshold distance of the first embedding;
determining, based at least in part on an object of the plurality of objects of the multi-object image, a complementary object image; and
presenting the multi-object image and the complementary object image.

7. The computer-implemented method of claim 6, further comprising:
determining a primary object represented in the input image; and
generating the first embedding encoding features representative of the primary object.

8. The computer-implemented method of claim 6, wherein the input image is at least one of an image provided by a client device, an image provided by a seller of an object represented in the image, an image returned in response to a query, an image to be presented to a user as part of an exploration experience by the user, an image of a single object, or an image maintained in an image data store.

9. The computer-implemented method of claim 6, wherein determining the multi-object image, further includes:
comparing the first embedding with each of a plurality of object embeddings to generate respective similarity scores, wherein:
each object embedding corresponds to an object represented in at least one of a plurality of multi-object images;
each similarity score is indicative of a similarity between the input image and the object corresponding to an object embedding, the similarity determined based at least in part on a distance between the first embedding and the object embedding corresponding to the object; and
the multi-object image includes an object corresponding to a highest similarity score.

10. The computer-implemented method of claim 9, further comprising:
adjusting the similarity score based on at least one of a user preference, a user history, a popularity of objects represented by the object embeddings, or a category of the objects represented by the object embeddings.

11. The computer-implemented method of claim 6, further comprising:
generating a multi-object image data store that includes only multi-object images that:
correspond to at least one of a plurality of categories;
include at least two or more objects of a same category of the plurality of categories; and
exceed a minimum image quality;
generating, for each object represented in a multi-object image included in the multi-object image data store, an object embedding encoding features representative of the object;
associating the object embedding with the multi-object image that includes the object; and
maintaining each of the object embeddings in an object embedding index.

12. The computer-implemented method of claim 11, wherein determining the multi-object image further includes:
comparing the first embedding against at least some of the object embeddings of the object embedding index to determine an object embedding having a highest similarity score with the first embedding; and
determining the multi-object image as a multi-object image associated with the object embedding.

13. The computer-implemented method of claim 6, further comprising:
generating a complementary object image data store that includes only complementary object images that:
correspond to at least one of a plurality categories; and
exceed a minimum image quality;
generating, for each complementary object image, a complementary object embedding encoding features representative of the complementary object image; and
maintaining each of the complementary object embeddings in a complementary object embedding index.

14. The computer-implemented method of claim 13, wherein determining the complementary object image, further includes:
determining a complementary object embedding having a highest similarity score with the object embedding by comparing a first object embedding of a first object of the multi-object image against the complementary object embedding of the complementary object embedding index; and
selecting the complementary object image that is associated with the complementary object embedding having the highest similarity score.

15. The computer-implemented method of claim 6, further comprising:
receiving an interaction with the complementary object image; and
in response to the interaction, initiating a purchase of an object included in the complementary object image from a seller of the object.

16. The computer-implemented method of claim 15, wherein the complementary object image is provided by the seller.

17. A method, comprising:
maintaining, in a multi-object image data store, a plurality of multi-object images, each multi-object image:
including a representation of at least two objects, and
each of the at least two objects corresponding to a first category;
determining, based at least in part on a comparison of a first embedding corresponding to an input image with each of a plurality of object embeddings corresponding to objects represented in the plurality of multi-object images, a multi-object image of the plurality of multi-object images, wherein an object represented in the multi-object image is represented by an object embedding that is closest in distance to the first embedding;
determining, based at least in part on an object of the at least two objects of the multi-object image, a complementary object image; and
presenting the multi-object image and the complementary object image.

18. The method of claim 17, further comprising:
maintaining, in a complementary object image data store, a plurality of complementary object images, each complementary object image including an object, the object corresponding to a category of a plurality of categories, wherein the first category is included in the plurality of categories.

19. The method of claim 17, wherein the first category is at least one of a fashion category, a home décor category, a beauty category, a design category, an animals category, a Thanksgiving category, a food and drink category, a Do-It-Yourself category, a Christmas category, or a Weddings category.

20. The method of claim 17, wherein at least some of the plurality of multi-object images include a first object corresponding to the first category, a second object corresponding to the first category, and a third object corresponding to a second category that is different than the first category.
